(19) United States
(12) Patent Application Publication
(10) Pub. No.: US 2020/0349506 A1
(43) Pub. Date: Nov. 5, 2020

(54) METHOD AND SYSTEM FOR PREDICTING EXTENT OF LOSS

(71) Applicant: TRUENORTH SYSTEMS LTD, Tel Aviv (IL)

(72) Inventors: Shlomo LAHAV, Ramat-Gan (IL); Efrat Ben-Ami, Tel Aviv (IL)

(73) Assignee: TRUENORTH SYSTEMS LTD, Tel Aviv (IL)

(21) Appl. No.: 16/849,952

(22) Filed: Apr. 15, 2020

Related U.S. Application Data
(60) Provisional application No. 62/840,466, filed on Apr. 30, 2019.

(51) Int. Cl. G06Q 10/08; G06F 16/2457; G06Q 50/28

(52) U.S. Cl. CPC G06Q 10/0838; G06F 16/24575; G06Q 50/28; G06Q 10/0833; G06Q 10/087; G06Q 10/0832

(57) ABSTRACT

The present disclosure describes method and system for recommending on a certain alternative for transporting a certain type of goods from an origin to a destination, wherein the recommendation is based on the predicted extent of loss (EoL) that is related to each alternative. Some example embodiments of the disclosed technique may express the EoL by two or more ranks.

### CROSS-REFERENCE TO RELATED APPLICATIONS

This utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the United States provisional application for patent that was filed on Apr. 30, 19 and assigned the Ser. No. 62/840,466, which application is herein incorporated by reference in its entirety. Further, this utility patent application is related to utility patent application U.S. Ser. No. 16/658,138; U.S. Ser. No. 16/658,143; and U.S. Ser. No. 16/658,151 that were filed on Oct. 20, 19, which applications are herein incorporated by reference in their entirety.

### FIELD OF THE INVENTION

The present disclosure relates to the field of cargo transportation. More particularly, the disclosure relates to a cargo management system for predicting the Extent-of-Loss (EoL) that may occur to a certain type of cargo during transportation from one point to another or while being stored in a warehouse.

### BACKGROUND OF THE INVENTION

Common cargo transportation is implemented by a shipping unit. An example of a cargo shipping unit (CSU) can be a container, an air parcel, etc. A common CSU provides an enclosed space in which physical items can be stored during shipment. A single journey of a CSU can comprise a plurality of segments. In each segment a different entity can be responsible for the safety of the CSU and its cargo.

An example of a journey of a CSU from an origin (such as but not limited to a factory, a warehouse, a retail outlet, etc.) to a destination (such as but not limited to a warehouse, a retail outlet, a customer premises, etc.) can comprise a plurality of segments. Segments such as but not limited to: loading the goods into the CSU at the shipper's platform; loading the CSU on a truck or a train at the shipper's yard; transporting the CSU toward the port or the airport; off-loading the CSU from the truck or the train; storing the CSU at the port or airport; embarking the CSU on the ship or airplane; transporting the CSU by the ship or the airplane; off-loading the CSU from the ship or airplane; temporary storing the CSU in the port (airport); loading the CSU on a truck or a train; transporting the CSU toward the consignee's yard; and downloading the CSU from the truck to the consignee's platform. Along the disclosure and the claims the terms origin, shipper and supplier can be used interchangeably and the terms destination, consignee, supplier's customer, or customer can be used interchangeably.

A person with ordinary skill in the art of cargo transportation can appreciate that some journeys may comprise all the above segments; other journeys may comprise part of those segments; and some journeys may comprise more segments than the ones that are disclosed above. Yet in some journeys the order of the segments can be other than the above disclosed order. It should be noted that the disclosed segments of a journey are not intended to limit the scope of the inventive concepts in any manner.

A common CSU may have a plurality of sensors. Some of the sensors are configured to monitor: acceleration, shocks, pressure, temperature, light, humidity, concentration of CO₂, concentration of O₂, tilt, timers, microphones, magnetic sensors at the doors, wireless communication capabilities, etc. Some of the sensors can be sensitive to two or more parameters. An example of such a combined sensor can be “MultiSensor 6”. “MultiSensor 6” can deliver information regarding motion, temperature, humidity, light, vibrations, and ultraviolet light (UV) as well as wireless communication based on Z-Wave protocol. “MultiSensor 6” is a trade name of Aeotec Inc USA. Z-Wave protocol is well known to a person with ordinary skill in the art and will not be further disclosed.

The readings of those sensors can be used for determining whether a filed form that describes a loss is related to occurred damages or not. Further, the reading of those sensors can be used for determining in which segment the loss occurred and which party might be responsible for the loss. Furthermore, the reading of the sensors can be used for predicting the EoL that may occur.

The EoL can be expressed as the percentage of the cargo that was damaged or as a portion of the cargo that was damaged. The percentage of the cargo that was damaged can be referred to the value of the cargo or to the volume of the cargo. For example, in a journey in which the cargo is panels of marble then the EoL can be the portion of a panel, or the number of panels that were damage divided by the total number of panels, or a combination of the two.

There are journeys in which different entities are responsible for the safety of the cargo. Each entity can be responsible for one or more segments of a journey. A truck company can be responsible for losses that occur during traveling by a truck. A sea carrier can be responsible for loading the cargo to the ship, loss that occurs during the ship traveling or when off-loading the CSU from the ship, etc. Thus, pointing on one or more segments in which the loss occurred can be essential, for some of the involved parties. Generally the term “claim for alleged loss” is used instead of the term “form that describes a loss” however in order to distinguish this type of claim from a “claim” as is used in the context of patent submissions, we will refer to “claim for alleged loss” henceforth as a “form that describes a loss” (FTDL).

Each one of the above mentioned entities might be interesting in knowing the predicted value of the EoL that may occur while the CSU is under the responsibility of that entity. Knowing the predicting EoL may lead to some operating decisions such as but not limited to where to put the CSU in a vehicle or a warehouse, which temperature, humidity, socks, etc. needs to be controlled while transportation or storing a certain CSU carrying a certain type of goods, etc. Knowing the EoL in a certain segment for a certain type of CSU and a certain type of goods can be one of the factors that can influence the cost of delivery that shipment, alternatively knowing the EoL may help a shipper to select a certain vehicle or a certain location in the vehicle or a certain CSU or a certain path of the voyage, etc. Last but not the least predicting the EoL for a certain case, a certain FTDL, may support a human surveyor while examining a certain demand for loss. Thus, there is a need for a system and a method that can predict the EoL for a certain case. Such a system can be an important tool in the tool box of a shipper.

### SUMMARY OF THE DESCRIPTION

The needs and the deficiencies, which are disclosed above, which related to predicting the value of the EoL of a certain case are not intended to limit the scope of the inventive concepts of the present disclosure in any manner. The needs are presented for illustration only.

Example embodiments of the present disclosure seek to provide a novel technique for calculating the predicted EoL for a certain type of goods carried by a certain type of CSU along a certain path of a journey by a certain vehicle, using a certain environmental control. In order to calculate the predicted EoL an example embodiment need to build an historical database (HDB). Each record in the HDB can be related to a certain journey (shipment) in which a form that describes a loss (FTDL) was filed and the FTDL was found as a valid FTDL.

Each record (entry) in the HDB may comprise related information such as but not limited to: the number of CSUs that are associated with the shipment, the type of the CSUs, the type of the cargo, reading of the sensors, indication that losses were occurred along the journey of a CSU, the EoL that was found by human surveyor, indication on the segment of the journey in which the damage was occurred, etc.

An example embodiment of the present disclosure may comprise a Form-Receiving Unit (FRU), a loss-analyzer unit (LAU), operational-recommending-unit (ORU), a predictive-model generator (PMG), a risk analyzing unit (RAU) and one or more databases.

An example embodiment of the present disclosure may be associated with one or more external databases that store general information, which is related to cargo transportation. For convenience and clarity of presentation the present disclosure refers to a plurality of databases, each database can be associated with one or more types of information. However, a person with ordinary skill in the art can appreciate that two or more of those databases may be embodied on one or more physical or virtual media. Media such as but not limited to, a read/write hard disc, CDROM, Flash memory, ROM, or any other non-transitory computer readable memory or storage devices.

Some examples embodiments of the disclosed technique may communicate with the external databases by using communication protocol such as but not limited to Internet Protocol (IP). The external DBs can be such as but not limited to: one or more databases (DB) of journeys, one or more DBs of CSUs, one or more DBs of types of cargo, one or more DBs of sensors, one or more DBs that contain weather information, one or more DBs that contain weather information about vehicles, etc. Such data are examples of “information regarding a route”. In some embodiments, one or more DBs can reside over the Internet cloud.

Each entry in an example of journey DB can be associated with a course from a shipper to a consignee. In some cases the shipper and/or the consignee premises can be substituted with an appropriate street, city, district, state, etc. depending on the resolution of the current stored data in the journey DB. Some embodiments of the disclosed technique can be configured to improve the resolution of the stored data at the end of each journey. Each course can comprise a plurality of segments. Each segment can be associated with one or more possible carriers. Such data are too examples of “information regarding a route”.

Each entry in an example of CSU DB may store information about features of a plurality of CSUs. Features such as but not limited to the material from which the CSU is made, the dimension of the CSU, whether the CSU includes environmental control devices, which sensors are associated with the CSU, whether the CSU is sealed to liquid and/or gas, previous damages, etc. Such data are too examples of “information regarding a route”.

Each entry in an example of cargo DB may store features of a certain type of cargo. Features such as but not limited to cost, sensitivity to shocks, sensitivity to temperature, sensitivity to humidity, sensitivity to CO₂, sensitivity to O₂, sensitivity to water, does it carry liquid, is the cargo explosive, etc. Such data are too examples of “information regarding a route”.

Each entry in an example of sensors DB can be associated with a type or a model of a sensor and may comprise the one or more parameters that are measured by the sensor (shock, humidity, temperature, etc.), the sensitivity of the sensor, the range that the sensor can measure, the tolerance of the readings, the sensors' firmware and hardware versions, etc. Such data are too examples of “information regarding a route”.

An example of weather DB may store information about the weather according to location, and time. The resolution of the time can be seasons, months, day or even the hour. Such data are too examples of “information regarding a route”.

Some embodiments of the disclosed technique can be configured to update the stored data or to improve the resolution of the stored data in one or more of the DBs. Other embodiments of the disclosed technique can be configured to update the stored data in the DBs or to improve the resolution of the stored data during a current journey.

In addition to the one or more external databases, some embodiments of the disclosed technique may comprise internal DBs. The internal DBs may store proprietary information. The proprietary information may comprise historical information. Each entry in the historical DB (HDB) can comprise information related to a journey, information related to the cargo, information related to the type of the CSU, etc.

In addition, the entry in the HDB may store an indication whether an FTDL was filed or not. If an FTDL was filed, the related stored information may be comprised of: the type of the damage, the extent of loss (EoL), the reading of the sensors, etc. The extent of loss can be expressed as the portion of the cargo that was damaged, in volume or in cost. In addition, an indication whether the loss-demand was approved, by a human (surveyor or otherwise) or not can be stored too.

An example of Form-Receiving Unit (FRU) can comprise one or more processors that are embedded in one or more computers. The computer can be Intel NUC, wherein NUC stands for Next-Unit-of-Computing or “Amazon EC2 A1 Instances” or “Amazon EC2 P3 Instances”, which are maintained by Amazon Crop USA, for example. An example FRU can be configured to obtain an FTDL in one or more formats, one or more units, etc. The obtained forms can be converted to a standard format in order to generate a standardized-form-that-describes-loss (SFTDL). Next the FRU may deliver a SFTDL to the LAU.

In some embodiments the FRU can be configured to communicate with a person that currently prepares the FTDL. In such embodiment the FRU can be configured to lead the person along the process of filling the one or more FTDLs.

An example of LAU can be a high-end computer with powerful Graphical-Processing Unit (GPU), for example, that is configured to execute one or more machine learning programs (MLP) in order to learn which recommending report to deliver per a certain loss-demand. A non-limiting example of a powerful computer can be “Amazon EC2 P3 Instances” maintained by Amazon Corp. USA and a non-limiting example of an MLP can be based on “TensorFlow” maintained by Google Brain Team USA, etc.

Other embodiments of the disclosed technique may use supervised machine learning algorithm such as but not limited to logistic regression, linear regression, decision tree, random-forest, etc. in order to generate a predictive function that can be used to predict the likelihood that damage will occur in a certain journey. In such embodiment the LAU can be configured to calculate the predicted likelihood for damage and compare it to a certain threshold. If the value of the predicted likelihood is higher than the threshold, then the FTDL can be marked as a valid FTDL, otherwise the FTDL can be marked a suspected FTDL.

Along the present disclosure and the claims the terms machine-learning program (MLP) and supervised machine learning algorithm can be used interchangeably. In the present disclosure and the claims the terms likelihood and probability can be used interchangeably.

Some example embodiments of LAU can be configured to calculate the predicted value of the EoL that may occur to a certain type of goods in a certain type of CSU in a certain journey. The EoL can be expressed as the percentage of the cargo that was damaged or as a portion of the cargo that was damaged or the percentage of the value of the cargo that was damage. For example, in cases in which the cargo is panels of marble then the EoL can be the portion of a panel, or the number of panels that were damage divided by the total number of panels, or a combination of the two.

In some embodiments of the disclosed technique calculating the EoL can be implemented upon obtaining a request from a shipper while considering the cost or the price for transporting a certain cargo from original to its destination, or along a certain segment of the journey. Further, some embodiments of the disclosed technique may use the EoL calculation in order to select one alternative from a plurality of options to deliver the cargo. For example, for selecting a path or a currier or a CSU, etc. Such example embodiment may calculate the EoL that is related to each alternative. The value of the EoL can be one of the factors that can be used in order to select one of the alternative ways. The other factors can be cost, duration of the journey, etc.

Some example embodiments of the disclosed technique may be configured to deliver operational recommendations based on the data that is stored in the history DB. Such embodiments may comprise an ORU. A shipper or a carrier that needs to deliver a certain cargo from a point A to point B may load to the ORU the type of the cargo, the origin location and destination, the requested date, requested cost, etc. The ORU may process the information in view of similar or partially similar journeys that are stored in the history DB and may deliver recommendation how to deliver the relevant cargo with a minimum risk for damage. Some embodiment may deliver duration estimation. The recommendations can refer to the type of CSU, the route of the journey, recommended carriers, ports, etc. Further, some embodiment may also calculate the predicted EoL that is related to the recommended journey and may present also the value of the predicted EoL.

Some example embodiments of the disclosed technique may be configured to process the stored data in the history DB and deliver a risk model. In such embodiments a risk analyzer unit (RAU) can associate a risk factor to one or more carriers, one or more types of CSUs, one or more segments, etc. At the end of processing the relevant information from the historical DB, an example of a RAU can predict the probability for damage along a certain journey. In some embodiment of the disclosed technique the risk report may be based on the calculated EoL that is related to the type of the cargo and the type of damage Based on the risk report a shipper or a carrier can determine which plan of a journey to select, which carrier, etc. Along the present disclosure and the claims the terms route of a journey and a plan of a journey can be used interchangeably.

An example of a predictive-model generator (PMG) can operate in two modes of operation, learning mode and ongoing mode. The learning mode can be executed after the initialization of the PMG and when the historical DB contains sufficient data to enable the MLP to start preparing a predictive model. During the learning mode new predictive models can be produced. The ongoing mode can be executed after the learning mode and may monitor and tune one or more existing predictive models. Along the present disclosure and the claims the terms predicting and predictive can be used interchangeably.

In some embodiments of the disclosed technique an example of PMG may be configured to generate a predictive model that can predict the extent of loss (EoL) that may be involved in a journey of a certain type of cargo in a certain CSU.

During the learning mode a number of journeys can be sampled by the PMG in order to define new predictive models. During the ongoing mode the predictive model can be updated.

The foregoing summary is not intended to summarize each potential embodiment or every aspect of the present disclosure, and other features and advantages of the present disclosure will become apparent upon reading the following detailed description of example embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

Other objects, features, and advantages of the present invention will become apparent upon reading the following detailed description of the disclosed embodiments with the accompanying drawings and appended claims.

### BRIEF DESCRIPTION OF THE DRAWINGS

Exemplary embodiments of the present disclosure will be understood and appreciated more fully from the following detailed description, taken in conjunction with the drawings in which:

FIG. 1 illustrates a simplified block diagram with relevant elements of an example of a cargo management system that operates according to the disclosed technique;

FIG. 2 schematically illustrates a flowchart showing relevant processes that can be implemented for collecting data, which is related to EoL, to be stored in a historical database;

FIG. 3 schematically illustrates a flowchart showing relevant processes that can be implemented by an example predictive-model generator (PMG) for generating a predictive model that can predict the rank of the EoL that may occur;

FIG. 4 schematically illustrates a flowchart showing relevant processes that can be implemented by an example of LAU for predicting the extent of loss (EoL) for a current case; and

FIG. 5 schematically illustrates a flowchart showing relevant processes that can be implemented by an example of operational-recommending-unit (ORU) for recommending a certain alternative of a certain journey based on the predicted EoL.

### DETAILED DESCRIPTION OF EXEMPLARY EMBODIMENTS

Turning now to the figures in which like numerals represent like elements throughout the several views, in which exemplary embodiments of the present invention are described. For convenience, only some elements of the same group may be labeled with numerals. The purpose of the drawings is to describe examples of embodiments and not for production purpose. Therefore, features shown in the figures are chosen for convenience and clarity of presentation only. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Unless stated otherwise, a component such as a processor or a non-transitory memory device described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments may implement the features and functionality described herein in software, firmware, or hardware as desired, including any combination of software, firmware, and hardware.

In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module.

Additionally, multiple modules of the same or different types may be implemented by a single processor. Software of a logical module may be embodied on a non-transitory computer readable storage device such as a read/write hard disc, CDROM, Flash memory, ROM, or other memory or storage, etc. In order to execute a certain task a software program may be loaded to an appropriate processor as needed. In the present disclosure the terms task, method, and process can be used interchangeably.

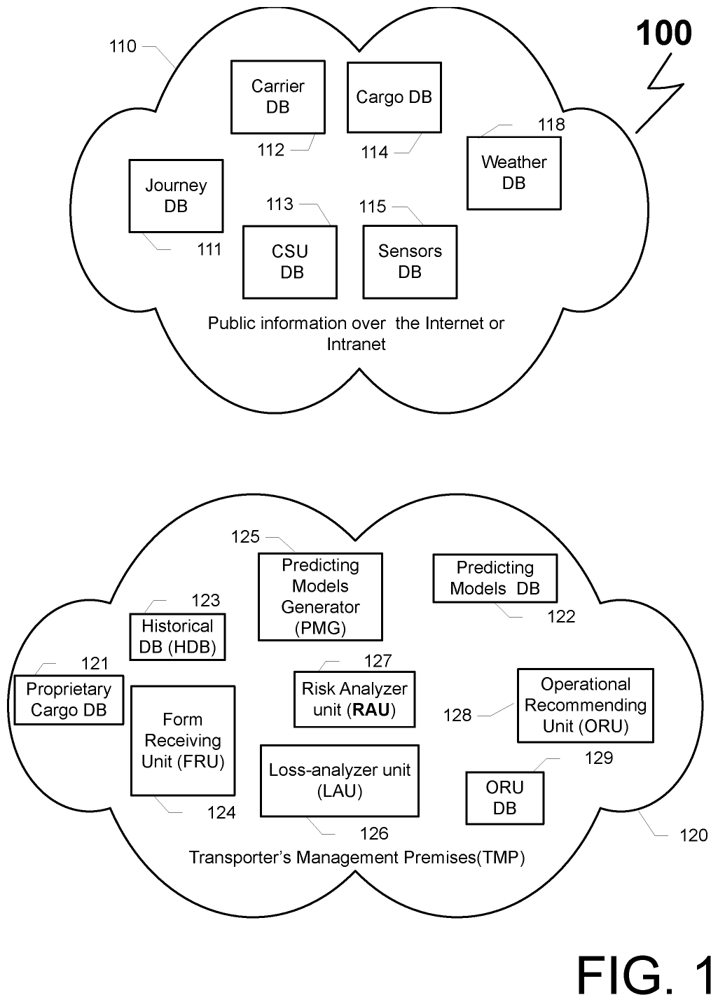

FIG. 1 depicts a simplified block diagram with relevant elements of an example of a cargo management system (CMS) 100 that operates according to the disclosed technique. An example of CMS 100 may comprise a public information network 110 and a proprietary information network 120. The public information network 110 can reside over the Internet, or over a plurality of Intranets (domains) of different entities. Entities may be entities that deliver containers, shipping services, carrier, ports, etc.

An example of public information network 110 can comprise a journey DB 111, a carrier DB 112, a CSU DB 113, a cargo DB 114, sensors DB 115 and weather DB 118. Other example of public information network 110 may comprise part of those DBs or additional DBs, such as but not limited to a shipper's DB (not shown in the figures). The shipper DB may store information related to a certain shipper. Information such as location, type of platform, previous demands for loss, payment history, etc.

Each entry in an example of journey DB 111 can be associated with a course from a shipper to a consignee. In some cases, the shipper and/or the consignee premises can be substituted with an appropriate street, city, district, state, etc. depending on the resolution of the current stored data in the DBs. Some embodiments of the disclosed technique can be configured to improve the resolution of the stored data at the end of each journey.

Each course can comprise a plurality of segments. Each segment can be associated with one or more possible carriers. Further, per each segment indication can be added about the history of occurred losses and related EoL per each case. Thus, analyzing the data that is stored in the journey DB 111 may provide insights about the EoL that can be associated with a certain course or a segment.

An example of carrier (transporter) DB 112 may comprise information related to a plurality of carriers. Each entry in the carrier DB 112 may comprise information related to a certain carrier. The carrier can be a sea-carrier, an air-carrier, a train company, a truck company, etc. The information may comprise sizes limitations of CSUs that can be handled by that carrier, weight limitations, scheduling information, possible routes, history of losses were involved with this carrier, etc.

CSU DB 113 may store information about a plurality of CSUs. Each entry in an example of CSU DB 113 may store information about features of a certain of CSU. Features such as but not limited to the material from which the CSU is made, the dimension of the CSU, whether the CSU includes environmental control devices, which sensors are associated with the CSU, whether the CSU is sealed to liquid and/or gas, previous damages, etc.

Cargo DB 114 may store information related to a plurality of types of cargo. Each entry in an example of cargo DB 114 may store features of a certain type of cargo. Features such as but not limited to cost, sensitivity to shocks, sensitivity to vibrations (amplitude and frequency), sensitivity to temperature, sensitivity to humidity, sensitivity to water, does it carry liquid, is the cargo explosive, etc. In addition, cargo DB 114 may store information regarding the packaging of the cargo, is it boxes with the dimension and weight of each box. Is the cargo powder inserted in sacks, etc.

Sensors DB 115 may store information related to a plurality of types of sensors. Each entry in an example of sensors DB 115 can be associated with a type or a model of a sensor and may comprise one or more parameters that are measured by the sensor (shock, humidity, temperature, etc.), the sensitivity of the sensor, the range that the sensor can measure, the tolerance of the readings, etc.

Weather DB 118 may store information related to the weather in a plurality of locations and routes as well as in a plurality of periods of the year. An example of DB 118 can be arranged as a two-dimensional matrix. The first axis can be associated with a location, a segment along a certain route, etc. The second axis can associate with the month. Each cell (at a junction of a certain location and a certain month), in such an example of matrix, can include information regarding the weather, the lighting hours, the probability for a storm, etc. Some example embodiments of DB 118 may comprise dates in which storms were occurred with or without information about each storm. Other example embodiments of DB 118 may use other resolution per one or more axis of the matrix. In other examples the resolution of the time axis can be expressed in days and not in months, etc.

Referring now to the Transporter-Management-Premises (TMP) 120. TMP 120 can be a private domain of a certain shipper, a private domain of an insurance company, etc. An example of TMP 120 may comprise one or more private DBs and one or more processing devices. An example of TMP 120 may comprise: Proprietary-cargo DB 121, Predictive models DB 122, HDB 123, and operational-recommending-unit (ORU) DB 129. In addition, an example of TMP 120 may comprise few examples of processing devices, devices such as but not limited to: Form-Receiving Unit (FRU) 124, Predictive-models generator (PMG) 125, Loss-analyzer unit (LAU) 126, Risk-analyzer unit (RAU) 127, and Operational-recommending unit (ORU) 128.

An example of the Proprietary-cargo DB 121 may store proprietary information regarding types of cargo. Each entry in an example of DB 121 may store features of a certain type of cargo. Features such as but not limited to cost, sensitivity to shocks, sensitivity to vibrations (amplitude and frequency), sensitivity to temperature, sensitivity to humidity, sensitivity to water, does it carry liquid, is the cargo explosive, etc. In addition, each entry may comprise proprietary information which is related to losses that related to the relevant type of cargo. Information such as but not limited to the number of cases in which losses were occurred to this type of cargo, the EoL that is related to this type of cargo, etc.

The historical DB (HDB) 123 may store information that was gathered during the years of operational of the owner of the domain 120. The HDB 123 can be used for building predictive models that can predict the likelihood of a certain rank of the EoL in a certain journey may occur. Example ranks can be: full damaged (1.0); high (0.75); medium (0.5); low (0.25) and no damage (0). Each entry in the HDB 123 can comprise information related to a journey from an origin to a destination, information related to the type of cargo and the target features of that cargo, information related to the type of the CSUs, information regarding the segments of the relevant journey, information regarding different carriers that can be used along the journey, etc.

In addition, each entry in HDB 123 may store indication whether a loss was reported, the type of the damage, the reading of the sensors, etc. an indication about the EoL that was related to that case by a human surveyor. Periodically, the HDB 123 can be updated with information that was gathered during a recent period of time. Further, the information that is stored in the HDB 123 can be used for producing or updating one or more predictive models that can predict the likelihood that a certain rank of EoL may be involved in a future similar journey.

An example of predictive models DB 122 may store a plurality of predictive models that were produced by the owner of the TMP 120. Each predictive model can be used for calculating the probability for damage along a certain journey. The parameters that can be used in a predictive model can refer to the type of cargo, the type of CSU, the carrier, the course, segments in the course, the date, etc. The stored predictive models can be used by one or more of the processing units of TMP 120.

In some example embodiments of the disclosed technique predictive models DB 122 may store one or more predictive models that can be used for predicting the EoL that can be involved in a certain journey of a certain type of goods.

An example of ORU DB 129 may store a plurality of operational recommendations to be used by the owner of the TMP 120. Each entry in the ORU DB 129 may store recommendation that can be used for planning a certain journey of a certain type of cargo. The recommendation can point on a certain carrier, a certain route from the origin to destination, the predicted duration of each route, a certain location on the ship, recommended price for such combination of routes, carrier and cargo type, etc. Further, in some example embodiments of the disclosed technique, the recommendation can be based on the predicted EoL that is related to a similar journey.

An example of FRU 124 can comprise one or more processors that are embedded in one or more computers. The computer can be Intel NUC, wherein NUC stands for Next-Unit-of-Computing. Other embodiments of the disclosed technique may use computers such as “Amazon EC2 A1 Instances” or “Amazon EC2 P3 Instances”, which are maintained by Amazon Crop USA. Yet, other example embodiments may use computers such as “General purpose machine type family N1” which is maintained by Google, USA, etc.

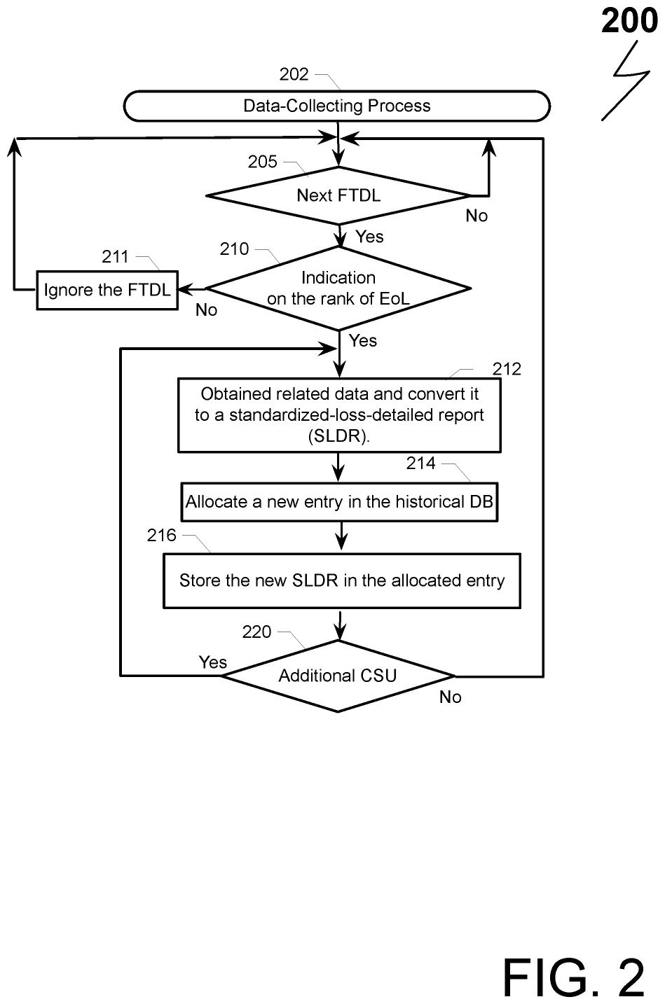

An example FRU 124 may be configured to obtain FTDLs submission in one or more formats, one or more units (kilogram, tons, pound, dollars, yen, kilometer, mile) etc. The obtained submissions can be converted to a standard format in order to produce a standardized-form-that-describes-loss (SFTDL). Next the FRU 124 may deliver SFTDL to a queue of the LAU 126. More information regarding an example process for data collecting by an example of FRU 124 is disclosed below in conjunction with FIG. 2

Among other tasks an example of PMG 125 can be configured to activate a machine-learning program (MLP) in order to scan the stored data in the HDB 123 and to deliver an updated predictive model to be stored in the predictive models DB 122. The updated predictive model can predict the probability that damage may occurred in a certain journey.

In some example embodiments of the disclosed technique PMG 125 may be configured to generate a predictive model that can predict the extent of loss (EoL) that may occur in a journey. The EoL can be expressed as the percentage or portion of the cargo, which was damaged. For example, in cases where the cargo comprises panels of marble or glass, then the EoL can express the portion of a panel that was damaged; or the number of panels that were damaged divided by the total number of panels; or a combination of the two. In some embodiment of the disclosed technique the EoL can be expressed in ranks: Example ranks can be: full damaged (1.0); high (0.75); medium (0.5); low (0.25) and no damage (0).

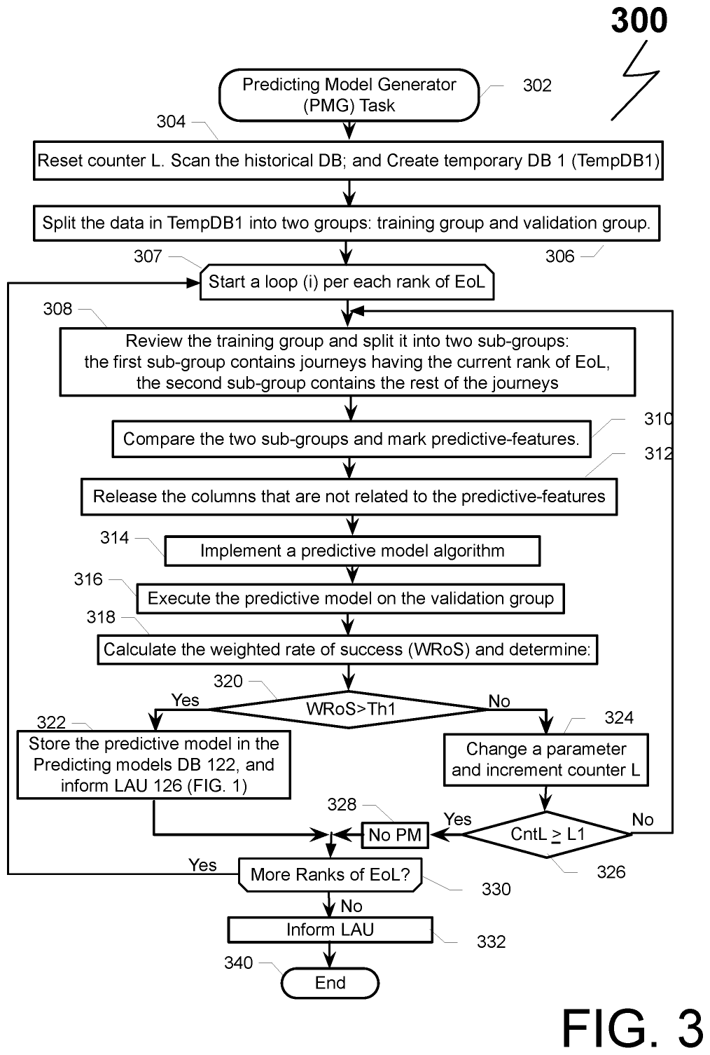

An example of predictive-model generator (PMG) 125 can operate in two modes of operation, learning mode and ongoing mode. The learning mode can be executed after the initialization of the PMG 125 and when the HDB 123 contains sufficient data to enable an example of an MLP to start preparing a predictive model for a certain journey and a certain type of cargo. Example embodiments of PMG 125 may use supervised machine learning algorithm such as but not limited to logistic regression, linear regression, decision tree, random-forest, etc. in order to create a predictive function that can be used to predict the likelihood that damage will occur in a certain journey. More information regarding the operation of PMG 125 is disclosed below in conjunction with FIG. 3.

The ongoing mode of operation can be executed after the learning mode and may monitor and fine-tune one or more existing predictive models that are stored in predictive model DB 122. A PMG 125 can be implemented by Intel NUC, or “Amazon EC2 A1 Instances” or “Amazon EC2 P3 Instances”, which are maintained by Amazon Crop USA, for example.

An example of LAU 126 can be a high-end computer that is configured to execute one or more MLPs for predicting the EoL that may be associated with a certain type of cargo embedded in a certain CSU, carried by a certain vehicle along a certain journey or a segment of a journey. A non-limiting example of LAU 126 can use computer such as but not limited to “Amazon EC2 A1 Instances” or “Amazon EC2 P3 Instances”, etc. A non-limiting example of a MLP can be based on “TensorFlow” maintained by Google Brain Team USA, etc.

Upon getting a request to predict the EoL for a certain case, an example embodiment of LAU 126 can be configured to scan the predictive models DB 122 looking for a valid predictive model that can apply to the current case. If a valid model does not exist, then the LAU 126 may request the PMG 125 to prepare such a predictive model. Some example embodiment of LAU 126 may use a classifier model instead of a predictive mode. Along the present disclosure the claims the terms predictive mode and classifier model can be used interchangeably.

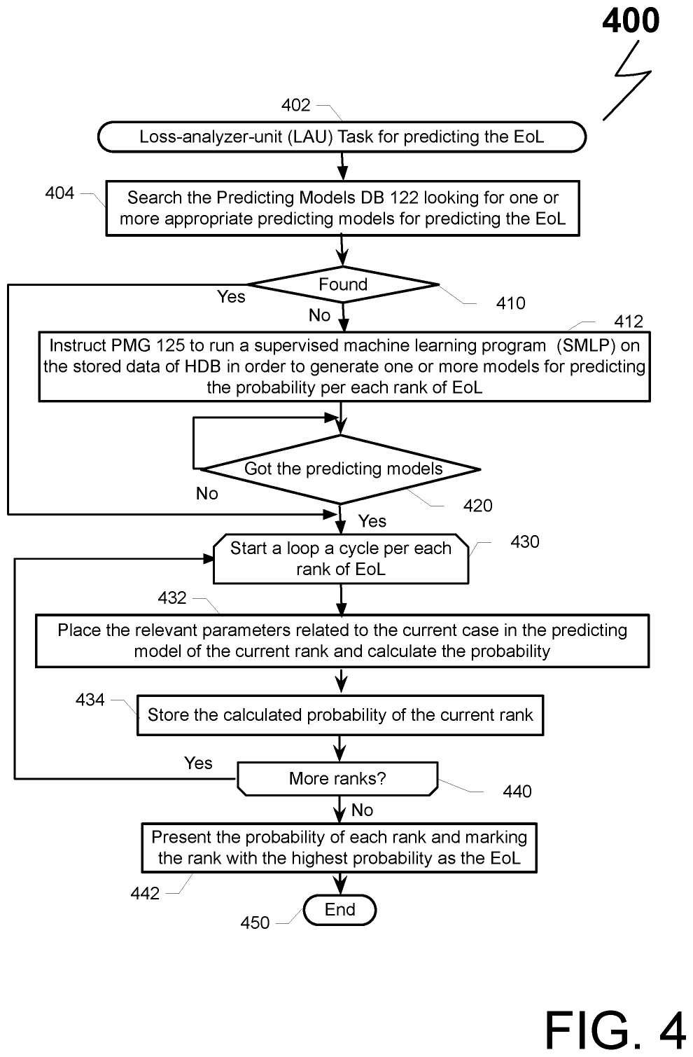

Upon obtaining an appropriate predictive model, LAU 126 may calculate the predicted EoL that may be associated with the current case. Knowing the predicted EoL can be one of the factors that may influence the cost of delivery that shipment, alternatively knowing the EoL may help a shipper to select a certain vehicle or a certain location in the vehicle or a certain CSU or a certain path of the voyage, etc. More information about the operation of LAU 126 is disclosed below in conjunction with FIG. 4.

Some example embodiments of risk analyzing unit (RAU) 127 can be configured to process the stored data in the history DB and deliver a risk model. By using the risk model an example of RAU 127 can predict the likelihood for damage along a certain journey. In some embodiment of the disclosed technique the risk report may be based on the calculated EoL that is related to the type of the cargo and the type of damage Based on the risk report a shipper or a carrier can determine which plan of a journey to select, which carrier, etc. Along the present disclosure and the claims the terms route of a journey and a plan of a journey can be used interchangeably.

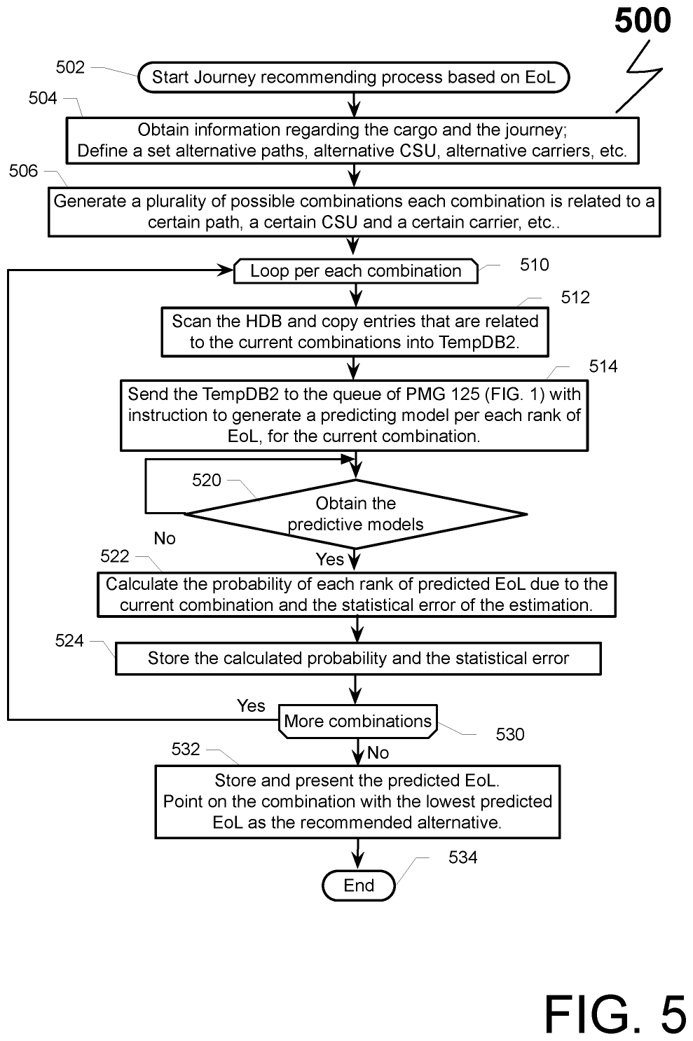

An example embodiment of ORU 128 may be configured to deliver operational recommendations based on the data that is stored in the HDB 123. A shipper that needs to deliver a certain cargo from a first place to second place may load to the ORU 128 the type of the cargo, the origin location and destination, the requested date, requested cost, the requested rank of the EoL, etc. The ORU 128 may process the information in view of similar journeys that are stored in the HDB 123 and may deliver recommendation how to deliver the relevant cargo in order to meet the requested rank of EoL. The recommendations can refer to the type of CSU, the route of the journey, recommended carriers, ports, recommendations where to put the CSU, etc. More information about the operation of examples ORU 128 is disclosed below in conjunction with FIG. 5.

Referring now to FIG. 2 that illustrates a flowchart of method 200. Method 200 can be implemented by FRU 124 (FIG. 1) for collecting data of a new case to be stored in the historical database (HDB) 123 (FIG. 1). Later on, the entry can be updated with the decision of the LAU 126 (FIG. 1) as it disclosed below in conjunction with FIG. 4 block 434. Method 200 can be initialized 202 after power on, and may run in a loop as long as the FRU 124 is active.

After initiation 202 process 200 may wait 205 to obtain a next FTDL. The form can comprise information such as but not limited to: date, cargo type; origin, destination, number of segments, per each segment: date origin, destination, carrier, vehicle, location on the vehicle, loss Y/N; reading of the sensors, the decision of a surveyor that check the FTDL, the cause of damage, etc. Next a decision is made 210 whether the FTDL comprise indication about the rank of the EoL. If 210 there is no indication on the EoL, then process 200 may ignore 211 the obtained FTDL and may return to block 205 waiting to the next FTDL.

If 210 the FTDL comprise information on the EoL, then the obtained FTDL can be further processing. However, similar features in different forms can be expressed in different units. Therefore, the FRU 124 may convert 212 the obtained form into a standardized-form-that-describes-loss (SFTDL).

An example of SFTDL can be a matrix in which the columns can be related to: locations (origin, destination), the session, the month, ports along the way, warehouses, cost of journey, segments of the journey, carriers, time, type of CSU, a column per each associated sensor, a column that indicates the decision of a human surveyor about the EoL, etc. Each one of those parameters can be referred as a parameter of interest (POI). The EoL can be expressed as a rank. Example of ranks can be: full damaged (1.0); high (0.75); medium (0.5); low (0.25) and no damage (0). In other embodiments the EoL can be expressed in percentages, etc. Each line in the matrix can be associated with one CSU from the one or more CSUs that are related to a certain shipment.

Similar parameters (features) in the SFTDL can be expressed by the same units. Following are few examples: the temperature can be presented in Celsius degrees; weight can be presented in Kilogram. Meter per second squared can be used for acceleration, EoL can be presented by five ranks, etc. Columns of a certain shipment, a certain SFTDL, that are associated to missing features can be remained empty.

Next, a new entry in the HDB 123 (FIG. 1) can be allocated 214 by FRU 124 (FIG. 1) and the new SFTDL can be stored 216 in that entry. At block 220 a decision is made whether additional CSU is included in the current FTDL (current shipment). If 220 yes, then process 200 returns to block 212 for handling the next CSU. If 220 there are no additional CSUs, then process 200 may return to block 205 for handling the next FTDL or may wait 205 to obtain a new FTDL.

FIG. 3 illustrates a flowchart with relevant processes of an example of method 300. Method 300 can be implemented by PMG 125 (FIG. 1), for example. Some embodiments of PMG 125 can be configured to generate a predictive model per a type of cargo, per a journey, per a period of the year, per the type of CSU, per type of vehicle, etc.

Process 300 can be initialized 302 by LAU 126 (FIG. 1) in order to generate a predictive model to be used for predicting the EoL of a certain type of cargo and a certain type of damage, as it is disclosed below in conjunction with block 422 in FIG. 4. Alternatively or in addition, process 300 can be initiated 302 periodically and generate one or more updated predictive models to be used for predicting the EoL for each type of loss. Example of periods can comprise few weeks, between one to five weeks, two weeks for example. The updated predicting models can be stored in predicting-models DB 122 (FIG. 1).

At block 304 method 300 may reset a counter that counts the number of loops that will be executed by PMG 126 in order to build a predictive model. This counter can be referred as counter L (CntL), thus the value of CntL is set to zero (CntL=0). Next PMG 126 may scan 304 the HDB 123 (FIG. 1) looking for entries that are related to similar journeys that are associated with justified FTDL. Further, those entries include an indication about the type of loss and indication about EoL that occur in that journey. Each found entry is copied to a temporary DB 1, TempDB1. The indication of the EoL can be expressed in percentages, or as a portion of the relevant freight or in ranks of damage. Example ranks can be: full damaged (1.0); high (0.75); medium (0.5); low (0.25) and no damage (0). In addition each copied entry may comprise an indication about the type of loss that occurred.

The type of damages for fruit may comprise frozen, ripening, physical damages, etc. The type of damages for cars can be external damages to the body of the car, rust, etc. The type of damages for panels of marble or glass can be cracks, scratches, or a combination of the two. For those panels, the EoL can be the portion of a panel that was damaged, or the number of panels that were damaged divided by the total number of panels, or a combination of the two.

It should be noted that a person having ordinary skill in that art will appreciate that copy of relevant entries from the HDB 123 (FIG) to a temporary DB can be done by just storing a link for a relevant entry in the HDB in an appropriate entry of the temporary DB.

At block 306 PMG 125 can split the TempDB1 into two groups, a training group and a validation group. Usually the training group has more entries than the validation group. An example of a training group can have 70% to 99% of the entries of TempDB1. A common training group can have the oldest 90% of the entries of TempDB1. Alternatively a K-Fold cross validation method can be used. K-Fold method are well known to a person having ordinary skill in the art and will not be further disclosed.

Next, a loop between block 307 to block 330 can be initiated. Each cycle of the loop can be related to one of the ranks that describe the EoL. The first cycle can be related to “full-damage” (rank 1.0) and the last cycle can be associated with “no-damage” (rank 0.0).

At block 308 the training group can be divided into two sub-groups. The first sub-group can comprise journeys (entries of TempDB1) having the current rank of the EoL. The second sub-group can comprise journeys (entries of TempDB1) in which there rank of EoL belongs to the other ranks of EoL. Next, process 300 may initiate a loop from block 310 to block 326. In each cycle of the loop a predictive model is generated and be checked. Alternatively, the first sub-group can comprise journeys in which the rank of EoL is equal or smaller than the current rank of EoL while the other sub-group can comprise journeys in which the rank of EoL is greater than the current rank of EoL.

At block 310 the two sub-groups are compared in order to mark one or more predictive-features. The predictive-features are features (columns in the first sub-group) having values that are substantially dissimilar from the values of the same features in the other sub-group. Features that emphasis the variance between the two sub-groups. Next, the features (columns) that are not marked as predictive-features can be released 312 from the two sub-groups.

At block 314 PMG 125 may execute a supervised machine learning algorithm that process the information that is stored in the two sub-groups in order to build a predictive model. Algorithms such as but not limited to logistic regression, linear regression, decision tree, random forest, etc. Then, at block 316 the predicted model is executed on the validation group and the weighted rate of success (WRoS) can be calculated 318.

The rate of success can be calculated by counting the number of journeys, from the validation group, in which the predictive model succeeded in predicting the rank of the EoL, divided by the amount of journeys that are included in the validation group. The WRoS takes into consideration the relation between the sizes of each sub-group (the size of the sub-group that is associated with the current rank of EoL and the size of the sub-group that is associated with the other ranks of EoL.

Next, a decision is made 320 whether the value of WRoS is greater than the value of a first threshold (Th1). Th1 can be a parameter in the range of few tens of percentages, 40% to 80%, for example. An example value of Th1 can be 65%. If 320 the WRoS is higher than Th1, then the calculated predictive model can be considered as a valid model for predicting the relevant rank of EoL and the valid model can be stored 322 in the predictive model DB 122 (FIG. 1) and process 300 can proceed to block 330.

If the value of WRoS is smaller or equal to Th1, then the value of one or more parameters can be changed 324. The parameters can comprise the value of Th1, the size of each sub-group, etc. In addition, CntL can be incremented 324 by one and a decision can be made 326 whether the value of CntL is greater or equal to a threshold L1. L1 can represent the maximum number of loops that can be implemented in order to define a predictive model for that rank of EoL. L1 can be in the range of two to five loops for example. A common value of L1 can be three times.

If 326 the value of CntL is equal or greater than L1, then process 300 can set 328 an indication that a predictive model cannot be generated for the current rank of EoL and process 300 can proceed to block 330. If the value of CntL is smaller than L1, then process 300 returns to block 308 and execute another cycle of the internal loop for generating a predictive model.

In an alternate example embodiment of process 300, at block 328, the PMG may use the created L1 predictive models. In such embodiments, the L1 predictive models can be ensemble into a single predictive model which is a weighted average of the L1 models

At block 330 a decision is made whether there are additional one or more ranks of the EoL. If yes 330, then process 300 returns to block 307 and start the process for the next rank of EoL. If 330 there is no any additional rank of EoL, then an indication can be sent 332 to the LAU 126 (FIG. 1), indicating that process 300 is terminated 340. In case in which PMG 125 (FIG. 1) has succeeded to generate one or more predicting models for predicting the rank of the EoL, the indication may comprise the addresses in which the relevant predicting models are stored in predicting-model DB 122 (FIG. 1).

Some example embodiments of PMG 126 can be configured to combine data of two or more types of damages in order to compute a predictive model for EoL. The two or more types of damage need to have some similarity. Following are few examples of damages that can be combined: broken panels of glass and broken panels of marble can be combined; frozen bananas and frozen apples can be combined, etc.

FIG. 4 schematically illustrates a flowchart showing relevant actions of a process 400. Process 400 can be implemented by LAU 126 (FIG. 1) for predicting the extent-of-loss (EoL) that is associated with a certain loss. In such example embodiment, process 400 can be executed by LAU 126 (FIG. 1) after determining that a “form that describes a loss” (FTDL) is justified. The predicted EoL may be added by LAU 126 to the recommendation that the LAU 126 may deliver at the end of analyzing the case that is associated with the relevant FTDL.

In some example embodiments process 400 can be initiated 402 by a transporter management system (TMS) in order to predict the EoL for transporting a certain type of goods, in a certain type of CSU in certain timing and a certain vehicle from a certain location to a certain destination. The predicted EoL can be used as one of the parameters for determining the cost of transporting that shipment from one place to the other.

Yet, some example of embodiments of process 400 can be initiated 402 by LAU 126 (FIG. 1) in order to define one or more parameters of a certain journey. Knowing the EoL may help a shipper to select a certain vehicle or a certain location in the vehicle or a certain CSU or a certain path of the voyage, etc. in order to reduce the predicted EoL of a certain shipment.

After initiation 402, process 400 can scan 404 the predicting-models DB 122 (FIG. 1) looking for one or more predicting models that can predict the EoL for a similar case. The similarity can be based on locations of the original and destination, segments, carriers, type of cargo, dates, weather, location in the vehicle, etc. If 410 such a predictive model is found, then process 400 proceed to block 430.

If 410 a predictive model does not exist in the predicting-models DB 122 (FIG. 1), then at block 412 process 400 may instruct PMG 125 (FIG. 1) to run a supervised machine learning program (SMLP) on the stored data of HDB 123 (FIG. 1) in order to generate one or more models for predicting the probability per each rank of EoL. Each predicting model can be configured to predict the likelihood of a rank, from the plurality of possible ranks of the EoL, which may be related to that shipment.

The instruction 412 can be associated with information regarding that shipment. Information such as but not limited to: locations of the original and destination, segments, carriers, type of cargo, dates, weather, location in the vehicle, etc. Then, at block 420, LAU 126 may wait to obtain an indication from PMG 125 (FIG. 1) that one or more models for calculating the predicted rank of EoL are ready and be stored in DB 122 (FIG. 1). The number of the predictive models depends on the number of types of losses that are involved with the relevant type of cargo. Accordingly the one or more predictive models are fetched from DB 122.

Upon obtaining the one or more predictive models, LAU 126 may start a loop between block 430 and block 440. Each cycle in the loop can be associated with a certain predicted rank of EoL. At block 432 parameters that are relevant to the current case, are placed 432 in the predictive model that is related to the current rank and the model is executed in order to deliver the probability that the predicted EoL is the current rank. The calculated probability that is related to the current rank of EoL can be stored 434 in a memory device that is associated with the LAU 126 (FIG. 1) or can be stored in the HDB 123 (FIG. 1).

The parameters may comprise parameters that can be retrieved from the relevant bill-of-lading (BoL); parameters that are related the segment, in which an example of LAU 126 determined that the damage had been occurred in that segment of the journey; telemetric parameters that were obtained by the sensors during the relevant segment of the journey; GPS information; in cases in which the relevant CSU includes an alarm device, then one of the parameters can be whether the alarm device was activated during the suspected segment of the journey, etc. The telemetric parameters may comprise: temperature, relative humidity, acceleration, vibration, etc.

Next, process 400 may check 440 whether additional rank of EoL exists. If 440 yes, then process 400 may start 430 a new cycle of the loop in order to calculate the probability that the next rank of EoL may occur. If 440, there is no possible rank of EoL, then process 400 may present 442 a report in which the probability of each possible rank of predicted EoL. In some embodiments the rank of EoL that is associated with the highest probability can be marked as the predicted EoL of the current case. Then, process 400 can be terminated 450.

Referring now to FIG. 5 that illustrates a flowchart showing relevant processes that can be implemented by method 500. Method 500 can be implemented by an example of operational-recommending-unit (ORU) 128 (FIG. 1) for recommending a certain alternative of a certain journey based on the predicted rank of EoL.

Process 500 can be initiated 502 by obtaining a request from a user, for example, to get a recommendation for conveying a certain type of goods from an origin to a destination. The user may define 504 a set of alternative paths between the relevant two ends (the origin and the destination of that journey), alternative CSUs, alternative carriers, etc. Some example embodiments of the disclosed technique may lead the user to define similar type of goods. The similar type of goods can be other type of fruit (bananas or apples), or other type of panels (glass or marble), etc.

At block 506 process 500 may generate a plurality of possible parameter combinations. Each combination can comprise one or more of the parameters, which may include but are not limited to each of the parameters presented herein above, as well as a certain path, a certain CSU, a certain vehicle, a certain carrier, etc. Next a loop between block 510 to block 530. Each cycle of the loop is associated with a certain combination. At block 512 the HDB 123 (FIG. 1) is searched looking for entries that are associated with the current combination. Those entries can be copied to a temporary DB2 (TempDB2). The TempDB2 can be transferred toward the queue of PMG 125 (FIG. 1) with instruction to generate a predicting model per each rank of EoL for that combination.

Next process 500 may wait 520 to obtain one or more predicting models, one per each rank of EoL. PMG 125 (FIG. 1) can be configured to execute a process similar to the process 300 that is disclosed above with few modifications. Block 304 (FIG. 3) can be modified by replacing the actions that are related to TempDB1 to be related to the obtained TempDB2; block 332 can be modified to inform the ORU 128 instant of informing LAU 126 (FIG. 1), for example.

Upon 520 obtaining the one or more predicting models, one per each rank of EoL, process 500 may calculate 522 the probability of obtaining each one of the ranks of EoL while using the current combination. In addition the statistical error of the estimation of each rank can be calculated too. The calculated probability and the statistical error can be stored 524 in the ORU DB 129 (FIG. 1) and a decision is made 530 whether there are additional combinations.

If 530 there is an additional combination, then process 500 returns to block 510 starting a new cycle for calculating the probability and the statistical error that are related to the additional combination. If 530 there is no additional combination, then process 500 proceeds to block 532. At block 532 the stored calculated probability and the statistical error can be presented to the user and let him to select one of the combination. Other example embodiments of process 500 may further analyze the stored calculated probability and the statistical error and the combination in which the lowest rank of EoL has the highest probability and acceptable statistical error can be marked as the recommended combination for conveying the certain type of goods from that origin to that destination and process 500 can be terminated 534.

In an alternate example of process 500 may calculate the probability per a rank of EoL per an individual element of a journey from the origin to the destination. The individual elements can be: type of CSU, ports, vehicles, carrier, period of the year, etc. Then, per each alternative combination the relevant elements can be selected with the value of the calculated probability per that element. Next the plurality of values can be ensemble into a single predicted value of EoL of that combination.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons having ordinary skill in the art that the present invention is not limited by what has been particularly shown and described herein above. Rather the scope of the invention is defined by the claims that follow.

1. A non-transitory computer readable memory device comprising executable instructions that when executed cause a processor at an Operational-Recommendation Unit (ORU) to:
i. obtain a plurality of parameters that are related to transporting a certain cargo from an origin to a destination;
ii. define a plurality of combinations of one or more of the plurality of parameters, wherein each combination can be used for transporting the certain cargo from the origin to the destination; and
iii. predict an extent of loss (EoL) per each combination.

2. The non-transitory computer readable memory device of claim 1, wherein the obtained parameters contain one or more parameters selected from the group of parameters consisting of: a type of the certain cargo; a type of the Cargo-Shipping Unit (CSU) in which the certain cargo is embedded, a season of the year that is related to the certain journey; a type of a vehicle transporting the cargo; a location in the vehicle and a path of the certain journey.

3. The non-transitory computer readable memory device of claim 1, further comprising an executable instruction that when executed causes the processor at the ORU to recommend a combination of the plurality of combinations for which the predicted EoL is minimal.

4. The non-transitory computer readable memory device of claim 1, wherein the EoL is expressed by two or more ranks.
claim The non-transitory computer readable memory device of claim 4, wherein per each combination the processor is further configured to:
a. calculate a probability to obtain each rank of the EoL; and
b. select a rank that is associated with the highest probability as the EoL of that combination.

6. The non-transitory computer readable memory device of claim 5, further comprising an instruction to recommend the combination that is associated with the lowest rank of EOL.

7. The non-transitory computer readable memory device of claim 1, wherein predicting the EoL of each combination is based on data that is stored in an historical database (HDB) that stores information regarding a plurality of journeys having indication on related EoL

8. The non-transitory computer readable memory device of claim 7, wherein the EoL is written in a related form that describes a Form That Describes a Loss (FTDL) of a valid loss.

9. The non-transitory computer readable memory device of claim 1, wherein the memory device is read/write hard disc.

10. A system comprising:
a. an operational recommendation unit (ORU) that is communicatively coupled with one or more databases (DBs);
b. wherein a processor at the ORU is configured to:
i. obtain a plurality of parameters that are related to transporting a certain cargo from an origin to a destination;
ii. define a plurality of combinations of one or more parameters of the plurality of parameters, wherein each combination can be used for transporting the certain cargo from the origin to the destination; and
iii. to predict an extent of loss (EoL) per each combination.

11. The system of claim 10, wherein the obtained parameters contain one or more parameters selected from a group of parameters consisting of: a type of the certain cargo; a type of the cargo-shipping unit (CSU) in which the certain cargo is embedded, a season of the year that is related to the certain journey; a type of the vehicle; a location in the vehicle and a path of the certain journey.

12. The system of claim 10, wherein the processor at the ORU is further configured to recommend a combination of the plurality of combinations for which the predicted EoL is minimal.

13. The system of claim 10, wherein the EoL is expressed by two or more ranks.

14. The system of claim 13, wherein per each particular combination of the plurality of combinations the processor is further configured to:
a. calculate a probability to obtain each rank of the EoL; and
b. select a rank that is associated with the highest probability as the EoL of that particular combination.

15. The system of claim 14, wherein the processor is further configured to recommend the combination that is associated with the lowest EoL,

16. The system of claim 10, wherein predicting the EoL of each combination of the plurality of combinations is based on data that is stored in an historical database (HDB) that stores information regarding a plurality of journeys having indication on related EoL.

17. The system of claim 16, wherein the EoL is disclosed in a related form that describes a loss (FTDL) of a valid loss.

18. The system of any of claim 10, wherein the processor is embedded in a computer.
